(19) United States
(12) Patent Application Publication
(10) Pub. No.: US 2002/0050089 A1
(43) Pub. Date: May 2, 2002

(54) Bullet lure with scent distributing body

(76) Inventor: Harry Robert Dixon, Bethlehem, NH (US)

Correspondence Address: Harry R. Dixon, RR1, Box 425, Bethlehem, NH, 03574, US

(21) Appl. No.: 09/888,045

(22) Filed: Jun. 21, 2001

Related U.S. Application Data
(60) Provisional application No. 60/213,927, filed on Jun. 26, 2000.

(51) Int. Cl. A01K 85/00

(52) U.S. Cl. 43/42.19

(57) ABSTRACT

A fishing lure with a modified ammunition cartridge case as the main body is provided. The empty cartridge case is modified by removing the primer cap and drilling one or a plurality of holes in the body of the case,for the purpose of scent distribution. Scent producing material is placed in the interior of the cartridge case and as the lure is pulled through the water a superior scent trail is spread behind the lure,caused by water washing through the case. The modified case provides a better method of both retaining the scented material and distributing the scent in a controlled manner. Preferably a single or treble hook and spinner blades or other decorative devises are attached by means of a wire connector passing through the shell casing to facilitate connection of all related parts.

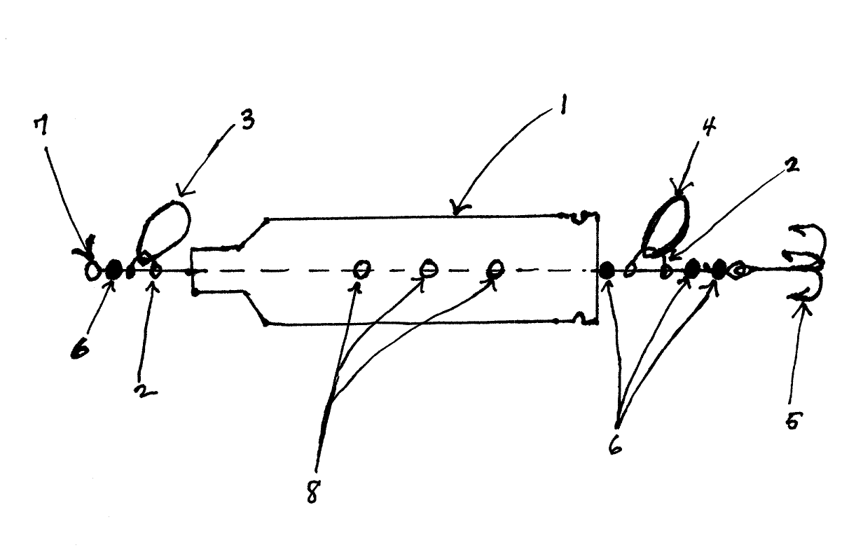

### CROSS REFERENCE TO RELATED APPLICATIONS

Not Applicable

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

The present invention is generally related to fishing lures and is therefore associated with U.S. Patent Class 43 and certain relevant sub-classes. More specifically,the invention provided relates to a fishing lure which,when packed internally with a scent producing material,and retrieved through the water,releases a scent trail directly behind said fishing lure in an efficient manner to attract fish and induce the fish to strike the lure.

It is scientifically known that many species of fish are attracted to certain scents. Therefore many fishing lure companies have tried many different methods of adding scent to their lures. One of the common problems has been that the scent producing material is often of tooth paste like consistency and washes off the lure,or falls of the lure during casting. Some lure companies have baked scent into rubber or plastic lures. The problems with that are (1) the scent can not be changed,and (2) the scent often releases much too slowly. One inventor,Jim Hugunin,(U.S. Pat. No. 6,161,324) provides a scent tab of absorbant material attached to the rear of the lure. The problem with this prior art is that the scented tab holds a small amount of material and has to be replenished frequently.

The present invention provided here solves a number of the problems associated with prior art. The present invention,consisting of a fishing lure provided with a modified,perforated,ammunition cartridge case body,various spinner blades and decorative beads,one or a plurality of hooks,and a means of attaching the lure to a fishing line,provides a practical method of storing scented material without unintentionally losing it,a method of distributing scent in a controllable manner,and a means of changing the scent, simply by washing out the cartridge case body and adding new scent.

Other relevant prior art is somewhat demonstrated in the following U.S. Pat. Nos. 6,082,038, 5,890,315, 5,915,945, 6,079,146, 5,787,633, and 5,775,023. Classes searched include the following: 43/42.06, 43/42.29, 43/42.19, 43/42.24, and 43/42.32, and also 43/42.25.

While the prior art may have served its purpose for which they address, they would not be as good for the purposes of the current invention herein described.

### BRIEF SUMMARY OF THE INVENTION

It is well known that many species of fish are attracted by a variety of scents emanating from a fishing lure as it is retrived through the water. The present invention provides a better method of both containing scented material and distributing the scent in a controllable manner from the inside of a modified cartridge case body. The spinner blades of the lure attract fish visually, and when the fish follow behind the lure the scent trail makes the fish much more likely to strike the lure. The fishing lure may have other decorative devises added to it and may have some of holes in the cartridge case body blocked off,or other holes added to adjust the rate of scent release for specific conditions.

### BRIEF DESCRIPTION OF THE ONLY VIEW OF DRAWING

The enclosed drawing of the present invention shows the prefered embodiment composed of the following numbered parts: (1) a 0.223 caliber ammunition cartridge case, (2) folded devises for retaining spinner blades, (3) # 0 Colorado spinner blade, (4) # 1 Colorado spinner blade, (5) treble hook, (6) orange flourescent plastic beads, (7) parts connecting wire, and (8) 1/8 inch drilled holes in cartridge case.

### DETAILED DESCRIPTION OF THE INVENTION

The only accompanying drawing depicts a fishing lure in accordance with the present invention. The preferred embodiment is constructed as follows the parts connecting wire 7 (made of 0.026 stainless steel) is cut to length, then 7 the parts connecting wire has a line connecting eyelet twisted at one end by a commonly available commercial wire bender. Next, a flourescent orange bead 6 is slid onto the parts connecting wire 7 from the untwisted end. Next, a size 0 Colorado spinner blade 3 is inserted onto a folded clevis 2, and then the folded clevis 2 with the spinner blade 3 is slid onto the parts connecting wire 7, from the untwisted end via the 2 holes in the clevis 2. Next, The untwisted end of the parts connecting wire 7 is inserted into the front end of an empty 0.223 calibur,standard,brass ammunition cartridge case 1 (with the primer removed) and pushed through the primer pocket at the rear end. Next,a flourescent orange bead 6 is slid onto the parts connecting wire 7 from the untwisted end. Next,a size #1 Colorado spinner blade 4 is inserted onto a clevis 2,and the assembly of 4 and 2 is slid onto the untwisted end of the parts connecting wire 7. Next,2 flourescent orange beads 6 are slid onto the parts connecting wire 7 from the untwisted end. Next,the untwisted end of the parts connecting wire 7 is bent 180 degrees,via a commercial wire bender, to both form a loop and make the end of the wire face back towards the line connecting eyelet at the front of the lure. Next,a treble hook 5 is slid onto the end of the parts connecting wire 7 and into the loop formed by the previous bend. Next,the last flourescent orange bead 6 that was slid onto the parts connecting wire7 is slid backwards over the parts connecting wire 7 to engage the end of the parts connecting wire 7 that was bent 180 degrees towards the line connecting eyelet. Thus the last flourescent orange bead has 2 sections of the parts connecting wire 7 inserted through it and therefore holds the treble hook 5 in the loop formed at the rear end of the lure by the previous bend.

In practice the cartridge case body of the lure 1 is filled with scent producing material. As the lure is retrieved the scent is emmitted through the primer pocket at the end of the lure and through the 1/8 inch drilled holes 8 in the cartridge case body 1.

While the previous detailed description of the preferred embodiment of the present invention,it should be understood that the present invention shall not be limited to the preferred embodiment,and in fact is intended to cover numerous variations within the spirit and scope of the present in vention. Some of the more common variations would include (but not be limited to) variations in caliber size of the cartridge case, variations in the size or number of hooks, variations in the size or number of drilled holes in the cartridge case, variations in the size or number of spinner blades, and any other decorative additions.

What I claim as my invention:

1. A fishing lure with an empty modified brass ammunition cartridge case as the main body.

2. A fishing lure as in claim 1, in which the main body of the lure has been modified specifically to release scent through the primer pocket and the plurality of holes drilled in the cartridge case body.

3. A fishing lure as in claim 2 in which the plurality of holes in the cartridge case body were designed to release scent in a controlled manner.

4. A fishing lure as in claim 3 in which the scent release can be adjusted by blocking 1 or more of the plurality of holes in the main body.

5. A fishing lure as in claim 4 which provides a larger amount of storage space for scented material than prior art.

6. A fishing lure as in claim 5 which a better method of storage of scented material,thus preventing accidental loss of said material.

7. A fishing lure as in claim 6 which provides an easier method of changing scents,simply by washing out the cartridge case body and adding new material.
